(19) United States
(12) Patent Application Publication
(10) Pub. No.: US 2009/0283933 A1
(43) Pub. Date: Nov. 19, 2009

(54) CERAMIC MEMBER AND METHOD FOR PRODUCING THE SAME

(75) Inventors: Yoshimasa Kobayashi, Nagoya-Shi (JP); Toru Hayase, Nagoya-Shi (JP); Naohito Yamada, Kasugai-Shi (JP)

Correspondence Address: BURR & BROWN, PO BOX 7068, SYRACUSE, NY, 13261-7068, US

(73) Assignee: NGK Insulators, Ltd., Nagoya-Shi (JP)

(21) Appl. No.: 12/511,339

(22) Filed: Jul. 29, 2009

Related U.S. Application Data
(62) Division of application No. 11/384,153, filed on Mar. 17, 2006.

(30) Foreign Application Priority Data
Mar. 25, 2005 (JP) 2005-090236

(51) Int. Cl. B29B 13/02

(52) U.S. Cl. 264/271.1

(57) ABSTRACT

A ceramic member is provided, including a ceramic sintered body and a metallic member, which includes a metal element, formed to be in contact with the ceramic sintered body. An affected layer around the metallic member of the ceramic sintered body has a thickness of 300 μm or less.

### CROSS REFERENCE TO RELATED APPLICATIONS

This application is a division of U.S. patent application Ser. No. 11/384,153, filed Mar. 17, 2006, and claims the benefit of priority from prior Japanese Patent Application P2005-090236 filed on Mar. 25, 2005, the entire contents of which are incorporated by reference herein.

### BACKGROUND OF THE INVENTION

1. Field of the Invention

The present invention relates to a ceramic member and a method for producing the same.

2. Description of the Related Art

Conventionally, in semiconductor manufacturing devices and liquid crystal manufacturing devices, a ceramic member, such as an electrostatic chuck or a heater, having embedded in a ceramic sintered body a metallic member, such as an electrostatic electrode or a resistance heating element, has been used. The ceramic member has a substrate-mounted surface on which a substrate, such as a semiconductor substrate or a liquid crystal substrate, is mounted. In recent years, as the size of the substrate and the integration degree increase, there are demands on the ceramic member where the substrate-mounted surface should have temperature uniformity.

One of the causes of inhibiting the temperature uniformity is an interaction between the metallic member and the ceramic sintered body during the production process. This interaction causes the metallic member to change in properties, so that the volume resistance of the metallic member is changed. In the ceramic sintered body, a wide range of the texture (microstructure) around the metallic member changes, so that properties including the thermal conductivity are changed. Consequently, the temperature uniformity of the resultant ceramic member becomes poor.

For solving the problems, a technique disclosed in Japanese Patent Application Laid-open No. H11-228244 for forming on the surface of a metallic member a phase which prevents diffusion of molybdenum into a ceramic sintered body, and a technique disclosed in Japanese Patent Application Laid-open No. 2003-288975 for preventing carbonization of a metallic member have been proposed.

In the technique described in Japanese Patent Application Laid-open No. H11-228244, diffusion of the metallic member into the ceramic sintered body can be prevented; however, the metallic member itself cannot be satisfactorily prevented from changing in properties. In the technique described in Japanese Patent Application Laid-open No. 2003-288975, carbonization of the metallic member can be prevented; however, the ceramic sintered body cannot be satisfactorily prevented from changing in properties. Therefore, the temperature distribution of a conventional ceramic member cannot meet the recent requirements for the temperature uniformity.

Accordingly, it is an object of the present invention to provide a ceramic member having good temperature uniformity and a method for producing the same.

### SUMMARY OF THE INVENTION

The ceramic member of the present invention includes a ceramic sintered body, and a metallic member that includes a metal element and is formed to be in contact with the ceramic sintered body, wherein the ceramic sintered body has an affected layer with a thickness of 300 μm or less around the metallic member.

In the ceramic member, the affected layer of the ceramic sintered body around the metallic member in contact with the ceramic sintered body has a thickness as small as 300 μm or less. The reason for this is that, even when the metallic member is in contact with the ceramic sintered body, the interaction between the ceramic sintered body and the metallic member during the production process is satisfactorily suppressed. Therefore, both the ceramic sintered body and the metallic member are prevented from changing in properties, so that the ceramic member can achieve good temperature uniformity.

It is preferred that the metallic member has a volume resistance change rate of 20% or less during a production process for the ceramic member. In this case, the metallic member can be more securely prevented from changing in properties, thus further improving the ceramic member in the temperature uniformity.

It is preferred that the metallic member includes at least one metal element selected from the group consisting of elements belonging to Groups 4a, 5a, and 6a.

It is preferred that the ceramic sintered body includes at least one element selected from the group consisting of rare earth elements and alkaline earth elements in an amount of 10% by weight or less, in terms of an oxide. In this case, the interaction between the ceramic sintered body and the metallic member during the production process can be more securely prevented, thus further improving the ceramic member in the temperature uniformity.

It is preferred that the ceramic sintered body includes aluminum nitride. In this case, the thermal conductivity of the ceramic sintered body can be improved, thus further improving the ceramic member in the temperature uniformity.

It is preferred that the metallic member is embedded in the ceramic sintered body. In this case, even when the ceramic member is used in a corrosive environment or a high-temperature environment, the metallic member can be prevented from being directly exposed to such an environment. Therefore, the ceramic member can be improved in corrosion resistance and heat resistance.

It is preferred that the metallic member is at least one member selected from a resistance heating element, an electrostatic electrode, and an RF (radio frequency) electrode. When the metallic member is a resistance heating element, the ceramic member can function as a heater. When the metallic member is an electrostatic electrode, the ceramic member can function as an electrostatic chuck. When the metallic member is an RF electrode, the ceramic member can function as a susceptor. Furthermore, when the metallic member is an electrostatic electrode and a resistance heating element, or an RF electrode and a resistance heating element, the ceramic member can function as an electrostatic chuck or a susceptor, which can be subjected to heating treatment.

The method for producing a ceramic member of the present invention includes the steps of: forming a ceramic compact; forming a metallic member including a metal element so that the metallic member is in contact with the ceramic compact; and sintering the ceramic compact and the metallic member. The ceramic compact has a relative density adjusted to 40% or more, and a ceramic sintered body at 1600° C. in the sintering step has a relative density adjusted to 80% or more. Furthermore, the sintering step includes a step of retaining an atmosphere under a reduced pressure at a temperature in the range of from 1500 to 1700° C.

The ceramic compact has a relative density adjusted to 40% or more and a ceramic sintered body at 1600° C. in the sintering step has a relative density adjusted to 80% or more, and the sintering step includes a step of retaining an atmosphere under a reduced pressure at a temperature in the range of from 1500 to 1700° C., and therefore, even when the sintering is conducted in a state such that the metallic member is in contact with the ceramic compact, the interaction between the ceramic compact and the metallic member can be satisfactorily suppressed. In other words, both the ceramic sintered body and the metallic member can be prevented from changing in properties. Therefore, there can be provided a ceramic member which includes a ceramic sintered body, and a metallic member formed to be in contact with the ceramic sintered body, wherein the ceramic sintered body has an affected layer around the metallic member wherein the affected layer has a thickness as small as 300 μm or less.

It is preferred that the metallic member has a volume resistance change rate of 20% or less in the sintering step. In this case, there can be provided a ceramic member having good temperature uniformity in which the metallic member is more securely prevented from changing in properties.

The relative density of the ceramic compact can be adjusted by changing at least one factor selected from, for example, the average particle size of a ceramic raw material powder, the type of a sintering aid, the amount of an added sintering aid, and the pressure for forming the ceramic compact. The relative density of the ceramic sintered body can be adjusted by changing at least one factor selected from, for example, the average particle size of the ceramic raw material powder, the type of the sintering aid, the amount of the added sintering aid, the pressure for forming the ceramic compact, and the sintering conditions.

It is preferred that the sintering step is performed using a hot press method. In this case, the ceramic member can be produced at a lower temperature, and therefore the interaction between the ceramic sintered body and the metallic member during the production process can be more securely prevented. In addition, the adhesion between the ceramic sintered body and the metallic member can be improved, obtaining a ceramic sintered body with a high density. Therefore, a ceramic member having good temperature uniformity can be provided.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is a cross sectional view of a ceramic member according to an embodiment of the present invention;

FIG. 2 is a cross sectional view of another ceramic member according to the embodiment of the present invention;

FIGS. 3A and 3B are respectively a cross sectional view and a plan view of IIIa-IIIa of a heater according to the embodiment of the present invention;

FIGS. 4A and 4B are respectively a cross sectional view and a plan view of IVa-IVa of an electrostatic chuck according to the embodiment of the present invention;

FIG. 5 is a photograph showing an SEM examination result around molybdenum according to an Example 5; and

FIG. 6 is a photograph showing an SEM examination result around molybdenum according to a Comparative Example 1.

### DETAILED DESCRIPTION OF THE INVENTION

Various embodiments of the invention are now described with reference to the Figures. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

### [Ceramic Member]

As shown in FIG. 1, a ceramic member 10 includes a ceramic sintered body 11 and a metallic member 12. The metallic member 12 is formed to be in contact with the ceramic sintered body 11. In the ceramic member 10, the ceramic sintered body 11 has an affected layer 11a around the metallic member 12 wherein the affected layer 11a has a thickness t as small as 300 μm or less. The affected layer 11a preferably has a thickness t of 200 μm or less, more preferably 100 μm or less. The affected layer 11a further preferably has the thickness t of 0 μm. In other words, it is especially preferred that the ceramic sintered body 11 has no affected layer 11a.

The affected layer 11a is a portion of the ceramic sintered body 11 which has changed in properties, and which results from a reaction of the ceramic sintered body 11 and the metallic member 12. The affected layer 11a is different from the portion of the ceramic sintered body 11, excluding the affected layer 11a, in respect of the texture (microstructure) or composition. More specifically, the affected layer 11a is in at least one state selected from a state where the component of the metallic member 12 has diffused through the ceramic sintered body 11, a state where the composition of the grain boundary phase formed from the component of the ceramic sintered body 11 (for example, a sintering aid), excluding the main component of the ceramic sintered body 11, is different from that of the portion other than the affected layer 11a, and a state where the distribution of the grain boundary phases formed from the component of the ceramic sintered body 11 (for example, a sintering aid), excluding the main component of the ceramic sintered body 11, is not equitable.

Thus, in the ceramic member 10, the affected layer 11a of the ceramic sintered body 11 around the metallic member 12 in contact with the ceramic sintered body 11 has a thickness t as small as 300 μm or less. The reason for this is that, even when the metallic member 12 is in contact with the ceramic sintered body 11, the interaction between the ceramic sintered body and the metallic member during the production process is satisfactorily suppressed. Therefore, both the ceramic sintered body 11 and the metallic member 12 are prevented from changing in properties, so that the ceramic member 10 can achieve good temperature uniformity.

The ceramic sintered body 11 and the metallic member 12 are individually described next in detail. As the ceramic sintered body 11, one including aluminum nitride (AlN), silicon carbide (SiC), silicon nitride (Si₃N₄), alumina (Al₂O₃), or sialon (SiAlON) can be used. It is preferred that the ceramic sintered body 11 includes aluminum nitride. In this case, the thermal conductivity of the ceramic sintered body 11 can be improved, thus further improving the ceramic member 10 in the temperature uniformity.

It is preferred that the ceramic sintered body 11 includes at least one element selected from the group consisting of rare earth elements and alkaline earth elements. It is preferred that the ceramic sintered body 11 includes at least one rare earth element selected from yttrium (Y), lanthanum (La), cerium (Ce), gadolinium (Gd), dysprosium (Dy), erbium (Er), ytterbium (Yb), and samarium (Sm). It is preferred that the ceramic sintered body 11 includes at least one alkaline earth element selected from magnesium(Mg), calcium (Ca), strontium (Sr), and barium (Ba).

It is preferred that the ceramic sintered body 11 includes at least one element selected from the group consisting of rare earth elements and alkaline earth elements in an amount of 10% by weight or less, in terms of an oxide. Specifically, it is preferred that the ceramic sintered body 11 includes at least one element selected from the group consisting of rare earth elements and alkaline earth elements in an amount of 10% by weight or less, in terms of an oxide of a rare earth element or in terms of an oxide of an alkaline earth element. In this case, the interaction between the ceramic sintered body 11 and the metallic member 12 during the production process can be more securely prevented, thus further improving the ceramic member 10 in the temperature uniformity.

With respect to the metallic member 12, there is no particular limitation as long as it includes a metal element. For example, as the metallic member 12, one formed from a single metal element or a plurality of metal elements, or a carbide of a metal element can be used. The metallic member 12 may include, for example, at least one metal element selected from the group consisting of elements belonging to Groups 4a, 5a, and 6a of the Periodic Table.

It is preferred that the metallic member 12 has a high melting point. For example, it is preferred that the metallic member 12 has a melting point of 1650° C. or higher. In this case, the interaction between the ceramic sintered body 11 and the metallic member 12 during the production process can be more securely prevented, thus further improving the ceramic member 10 in a temperature uniformity. Specifically, it is preferred that the metallic member 12 is molybdenum (Mo), tungsten (W), niobium (Nb), hafnium (Hf), tantalum (Ta), or an alloy or carbide thereof. Examples of alloys include tungsten-molybdenum alloys. Examples of carbides include tungsten carbide (WC) and molybdenum carbide (MoC).

It is preferred that the difference in coefficient of thermal expansion between the metallic member 12 and the ceramic sintered body 11 is 5×10⁻⁶/K or less. In this case, the adhesion between the ceramic sintered body 11 and the metallic member 12 can be improved. Furthermore, formation of cracks in the portion of the ceramic sintered body 11 around the metallic member 12 can be prevented.

Furthermore, it is preferred that the metallic member 12 has a volume resistance change rate of 20% or less during a production process for the ceramic member 10. In this case, the metallic member 12 can be more securely prevented from changing in properties, thus further improving the ceramic member 10 in a temperature uniformity.

Specifically, the production process for the ceramic member 10 includes a sintering step. This sintering possibly changes the volume resistance of the metallic member 12. Therefore, when the volume resistance of the metallic member 12 prior to the sintering is taken as “R1” and the volume resistance of the metallic member 12 after the sintering is taken as “R2”, a volume resistance change rate “Rr” during the production process for the ceramic member 10 can be represented by the formula (1) below. The change rate Rr is more preferably 10% or less, further preferably 5% or less.

Rr=|(R2−R1)/R1|×100(%) (1)

The metallic member 12 may be formed in any mode as long as it is in contact with the ceramic sintered body 11. It is preferred that the metallic member 12 is embedded in the ceramic sintered body 11 as shown in FIG. 1. In this case, even when the ceramic member 10 is used in a corrosive environment or a high-temperature environment, the metallic member 12 can be prevented from being directly exposed to such an environment. Therefore, the ceramic member 10 can be improved in corrosion resistance and heat resistance.

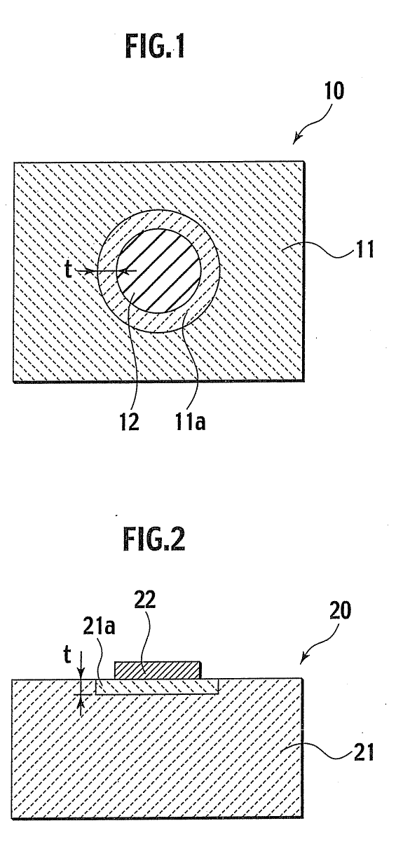

As seen in the ceramic member 20 shown in FIG. 2, the metallic member 22 may be formed on the surface of the ceramic sintered body 21. The affected layer 21a may be formed in the surface portion of the ceramic sintered body 21 with which the metallic member 22 is in contact. The affected layer 21a has the thickness t as small as 300 μm or less. The affected layer 21a preferably has the thickness t of 200 μm or less, more preferably 100 μm or less. It is especially preferred that the ceramic sintered body 21 has no affected layer 21a.

### [Method for Producing a Ceramic Member]

A method for producing the ceramic member 10 includes the steps of: for example, forming a ceramic compact; forming a metallic member including a metal element so that the metallic member is in contact with the ceramic compact; and sintering the ceramic compact and the metallic member. The ceramic compact has a relative density adjusted to 40% or more, and a ceramic sintered body at 1600° C. in the sintering step has a relative density adjusted to 80% or more. Furthermore, the sintering step includes a step of retaining an atmosphere under a reduced pressure at a temperature in the range of from 1500 to 1700° C.

The ceramic compact has a relative density adjusted to 40% or more and a ceramic sintered body at 1600° C. in the sintering step has a relative density adjusted to 80% or more, and the sintering step includes a step of retaining an atmosphere under a reduced pressure at a temperature in the range of from 1500 to 1700° C., and therefore, even when the sintering is conducted in a state such that a metallic member 12 is in contact with the ceramic compact, the interaction between the ceramic compact and the metallic member can be satisfactorily suppressed. In other words, in this method, both the ceramic sintered body 11 and the metallic member 12 can be prevented from changing in properties. Therefore, there can be provided the ceramic member 10 which includes the ceramic sintered body 11, and the metallic member 12 formed so that it is in contact with the ceramic sintered body 11, wherein the ceramic sintered body 11 has the affected layer 11a around the metallic member 12 wherein the affected layer 11a has the thickness t as small as 300 μm or less.

The steps are individually described next in detail. In the step of forming the ceramic compact, mixed powder of ceramic raw material powder and a sintering aid is prepared, and a binder, water or alcohol, a dispersant, and others are added to the mixed powder to prepare a slurry. The slurry is subjected to granulation by, for example, a spray granulation method to prepare granulated powder. The granulated powder is shaped using a shaping method, such as a molding method, a CIP (cold isostatic pressing) method, or a slip casting method, to form a ceramic compact.

The density of the ceramic compact is taken as “D (pr)”. In the sintering step at 1600° C., the ceramic compact is changing into a ceramic sintered body. Therefore, the density of the ceramic sintered body at 1600° C. in the sintering step is taken as “D(1600)”. When the theoretical density of the ceramic sintered body is taken as “D(th)”, the relative density “Dr(pr)” of the ceramic compact and the relative density “Dr(1600)” of the ceramic sintered body at 1600° C. in the sintering step can be represented by the formulae (2) and (3) below, respectively. The relative density Dr(pr) of the ceramic compact is more preferably 45% or more. The relative density Dr(1600) of the ceramic sintered body at 1600° C. in the sintering step is more preferably 85% or more, further preferably 95% or more.

Dr(pr)={D(pr)/D(th)}×100(%) (2)

Dr(1600)={D(1600)/D(th)}×100(%) (3)

It is preferred that at least one factor selected from, for example, the average particle size of the ceramic raw material powder used to form the ceramic compact, the type of the sintering aid, the amount of an added sintering aid, and a pressure for forming the ceramic compact is appropriately changed so that the relative density Dr(pr) of the ceramic compact becomes 40% or more. It is preferred that at least one factor selected from, for example, the average particle size of the ceramic raw material powder used to prepare the ceramic compact, the type of the sintering aid, the amount of the added sintering aid, and the sintering conditions is appropriately changed so that the relative density Dr(1600) of the ceramic sintered body at 1600° C. in the sintering step becomes 80% or more. The sintering conditions, for example, a sintering temperature, a sintering time, a sintering schedule, such as a rate of temperature increase, a sintering atmosphere, a sintering method, or retention conditions in an atmosphere under a reduced pressure (retention time, retention temperature, or pressure) can be changed. For example, these can be appropriately changed depending on, for example, the type of the ceramic raw material powder.

The average particle size of the ceramic raw material powder varies depending on the type of the ceramic raw material powder or the like. However, for example, it is preferred that the average particle size of the ceramic raw material powder is adjusted to 0.5 to 1.5 μm. It is more preferred that the average particle size of the ceramic raw material powder is adjusted to 0.5 to 1.0 μm.

As a sintering aid, for example, a compound including at least one element selected from the group consisting of rare earth elements and alkaline earth elements can be used. For example, an oxide including at least one rare earth element selected from yttrium, lanthanum, cerium, gadolinium, dysprosium, erbium, ytterbium, and samarium can be used as a sintering aid. It is preferred that an oxide including at least one alkaline earth element selected from magnesium, calcium, strontium, and barium can be used as a sintering aid. The amount of the added sintering aid is preferably 10% by weight or less. The amount of the added sintering aid is more preferably 0.05 to 10% by weight. The forming pressure is preferably 100 to 400 kgf/cm², more preferably 150 to 200 kgf/cm².

A shrinkage starting temperature at which the ceramic compact starts shrinking is determined substantially depending on the type or particle size of the ceramic raw material powder, the type of the sintering aid, or the amount of the added sintering aid. It is preferred that at least one factor selected from the particle size of the ceramic raw material powder, the type of the sintering aid, and the amount of the added sintering aid is changed to lower the shrinkage starting temperature. By lowering the shrinkage starting temperature, even when the sintering is conducted in a state such that the metallic member is in contact with the ceramic compact, the interaction between the ceramic compact and the metallic member can be satisfactorily suppressed. For example, when aluminum nitride is used as the ceramic raw material powder, it is preferred that the particle size of the ceramic raw material powder, the type of the sintering aid, or the amount of the added sintering aid is changed so that the shrinkage starting temperature becomes 1300 to 1500° C., more preferably about 1300 to 1400° C.

With respect to the method for forming the metallic member 12 so that it is in contact with the ceramic compact, there is no particular limitation. For example, a printing paste including powder of a material for the metallic member, such as metal powder or metal carbide powder, is prepared. The printing paste is printed on the ceramic compact by a screen printing method or the like to form the metallic member 12. In this case, it is preferred that the ceramic raw material powder is mixed into the printing paste. In this case, the coefficients of thermal expansion of the metallic member 12 and the ceramic sintered body 11 can be close to each other, improving the adhesion between them.

Alternatively, the metallic member 12 can be formed by placing wire, coiled, strip, mesh, or the perforated metallic member 12 in a bulk form, or the metallic member 12 in a sheet form (metallic foil) on the ceramic compact. Further alternatively, a thin film of the metallic member 12 may be formed on the ceramic compact by a physical vapor deposition process or a chemical vapor deposition process.

The step of forming the ceramic compact and the step of forming a metallic member can be achieved simultaneously. For example, a ceramic compact is formed as mentioned above. The metallic member 12 is formed on the ceramic compact, and a ceramic compact is further formed on the metallic member 12, thus forming a ceramic compact having embedded therein the metallic member 12. In this way, the formation of a ceramic compact and the metallic member 12 can be performed simultaneously. Also in this case, the finally obtained ceramic compact having embedded therein the metallic member 12 has a relative density adjusted to 40% or more, and a ceramic sintered body at 1600° C. in the sintering step has a relative density adjusted to 80% or more.

Alternatively, a ceramic compact is formed on the metallic member 12 in a bulk form, achieving the formation of the ceramic compact and the metallic member 12 simultaneously. For example, the metallic member 12 in a bulk form is placed in a mold, and the portion above the metallic member 12 in the mold is filled with the granulated powder, followed by molding.

In the step of sintering the ceramic compact and the metallic member, the ceramic compact and the metallic member are once retained in an atmosphere under a reduced pressure at a temperature in the range of from 1500 to 1700° C. For example, the ceramic compact and the metallic member can be retained in an atmosphere under a reduced pressure at a certain temperature in the range of from 1500 to 1700° C. for a certain time. Alternatively, the ceramic compact and the metallic member can be retained in an atmosphere under a reduced pressure by reducing the rate of temperature increase in the temperature range of from 1500 to 1700° C. The retention time in an atmosphere under a reduced pressure is preferably 10 hours or shorter, more preferably 0.5 to 5 hours.

The atmosphere under a reduced pressure is preferably at 1×10⁻² Torr or less, more preferably at 1×10⁻³ Torr or less. The temperature of the atmosphere under a reduced pressure is more preferably 1500 to 1600° C.

With respect to the sintering conditions other than the retention in an atmosphere under a reduced pressure at a temperature in the range of from 1500 to 1700° C., sintering conditions for the ceramic compact and the metallic member can be used according to the type of the ceramic raw material powder. Examples of usable sintering conditions include a sintering temperature, a sintering time, a sintering schedule, such as a rate of temperature increase, a sintering atmosphere, and a sintering method according to the type of the ceramic raw material powder. For example, when the ceramic raw material powder is comprised of aluminum nitride, the sintering atmosphere can be an atmosphere of inert gas, such as argon gas or nitrogen gas, or an atmosphere under a reduced pressure, or the sintering temperature can be 1700 to 2200° C. The sintering temperature is more preferably 1750 to 2100° C.

As the sintering method, a pressure-less sintering method or a hot press method can be used. It is preferred that the sintering is performed using a hot press method to form an integrated sintered material comprised of the ceramic sintered body 11 and the metallic member 12. In this case, the sintering can be conducted at a lower temperature, and hence a ceramic member can be produced at a lower temperature. Therefore, the interaction between the ceramic sintered body 11 and the metallic member 12 during the production process can be more securely suppressed. In addition, the adhesion between the ceramic sintered body 11 and the metallic member 12 can be improved, obtaining the ceramic sintered body 11 with a high density. Therefore, the ceramic member 10 having good temperature uniformity can be provided. The pressure applied in a hot press method is preferably 50 kgf/cm² or more.

Furthermore, it is preferred that the metallic member 12 has the volume resistance change rate Rr of 20% or less in the sintering step. In this case, there can be provided the ceramic member 10 having good temperature uniformity in which the metallic member 12 is more securely prevented from changing in properties. The change rate Rr is more preferably 10% or less, further preferably 5% or less. The volume resistance change rate Rr can be 20% or less by appropriately changing the sintering conditions, for example, a sintering temperature, a sintering time, a sintering schedule, such as a rate of temperature increase, a sintering atmosphere, or retention conditions in an atmosphere under a reduced pressure (retention time, retention temperature, or pressure).

The ceramic member described above can be applied to a variety of ceramic members required to have good temperature uniformity. Specific examples of the ceramic members are described next.

### [Heater]

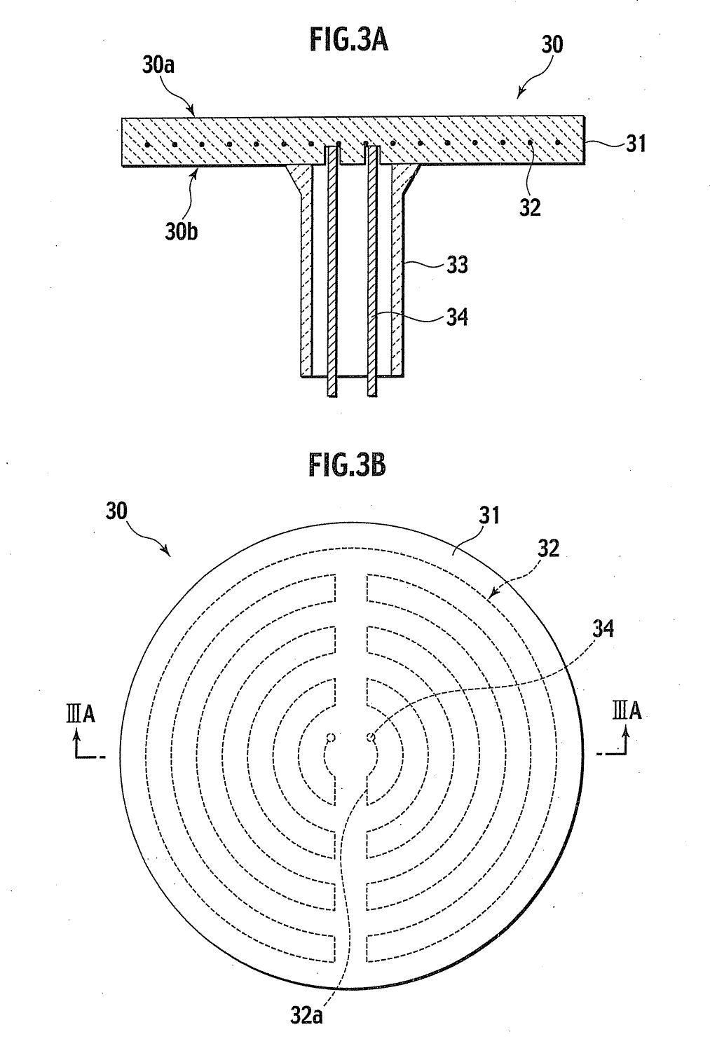

As shown in FIGS. 3A and 3B, a heater 30 includes a base 31, a resistance heating element 32, a tubular member 33, and a feeder member 34. The heater 30 has a substrate-mounted surface 30a on which a substrate, such as a semiconductor substrate or a liquid crystal substrate, is mounted. The heater 30 heats the substrate mounted on the substrate-mounted surface 30a.

The base 31 is comprised of a ceramic sintered body. The resistance heating element 32 is comprised of a metallic member. The resistance heating element 32 is embedded in the base 31. In the base 31, an affected layer around the resistance heating element 32 has a thickness as small as 300 μm or less.

The resistance heating element 32 is connected to a feeder member 34. The resistance heating element 32 receives power supply through the feeder member 34 to generate heat, raising the temperature of the substrate-mounted surface 31a. The pattern form of the resistance heating element 32 is not limited, and the resistance heating element can be in a form, for example, having a plurality of turn portions 32a as shown in FIG. 3B, or in a coiled form or a mesh form. Furthermore, the resistance heating element 32 may be comprised of either a single portion or a plurality of divided portions. For example, the resistance heating element can be comprised of two divided regions of the center portion and the circumferential portion of the substrate-mounted surface 30a.

A tubular member 33 supports the base 31. The tubular member 33 contains therein the feeder member 34. The tubular member 33 is joined to a back surface 30b of the base 31. For example, like the base 31, the tubular member 33 can be formed from a ceramic sintered body.

In the heater 30, both the base 31 and the resistance heating element 32 are prevented from changing in properties. Therefore, the properties including the thermal conductivity of the base 31 and the volume resistance of the resistance heating element 32 can be maintained. Thus, the heater 30 can keep uniform the temperature all over the substrate-mounted surface 30a, achieving good temperature uniformity, which meets the recent demands on temperature uniformity.

### [Electrostatic Chuck]

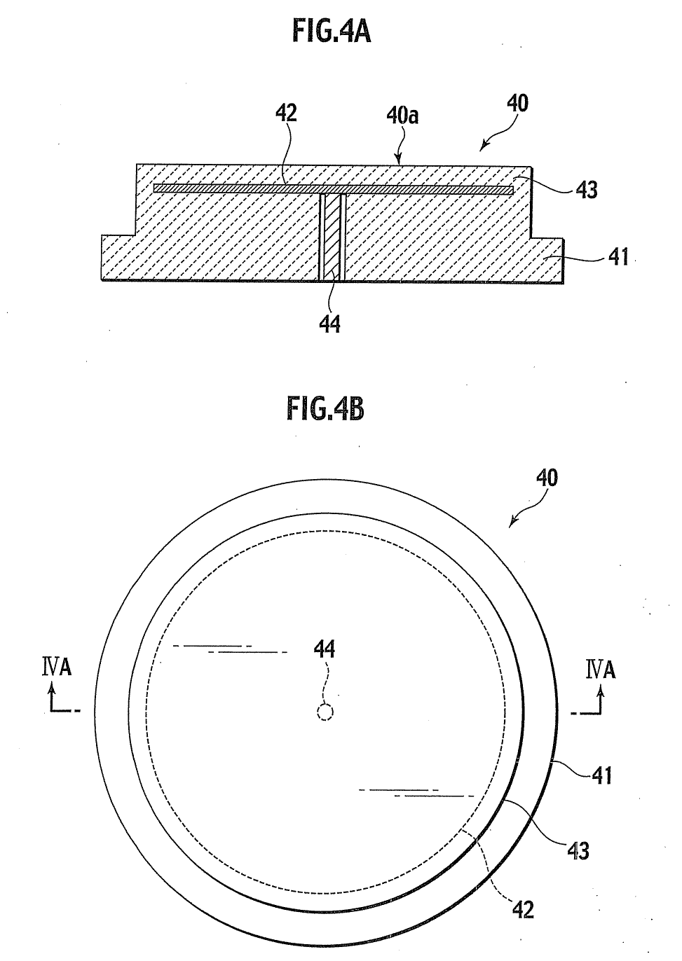

As shown in FIGS. 4A, 4B, an electrostatic chuck 40 includes a base 41, an electrostatic electrode 42, a dielectric layer 43, and a feeder member 44. The electrostatic chuck 40 has a substrate-mounted surface 40a, and adsorbs and holds a substrate mounted on the substrate-mounted surface 40a.

Each of the base 41 and the dielectric layer 43 is comprised of a ceramic sintered body. The electrostatic electrode 42 is comprised of a metallic member. The electrostatic electrode 42 is embedded between the base 41 and the dielectric layer 43. In the base 41 and the dielectric layer 43, an affected layer around the electrostatic electrode 42 has a thickness as small as 300 μm or less.

The electrostatic electrode 42 is connected to the feeder member 44. The electrostatic electrode 42 receives power supply through the feeder member 44 to generate electrostatic adsorptivity. The pattern form of the electrostatic electrode 42 is not limited, and the electrostatic electrode can be in a circular form, a semicircular form, a mesh form (metal mesh), a comb-teeth form, or a perforated form (punching metal). Furthermore, the electrostatic electrode 42 may be either of a single-pole type or of a dipole or multi-pole type.

In the electrostatic chuck 40, the base 41, the dielectric layer 43, and the electrostatic electrode 42 are prevented from changing in properties. Therefore, the properties including the thermal conductivity of the base 41 and the dielectric layer 43, the volume resistance of the dielectric layer 43, and the volume resistance of the electrostatic electrode 42 can be maintained. Thus, the electrostatic chuck 40 can keep uniform the temperature and electrostatic adsorptivity all over the substrate-mounted surface 40a, achieving good temperature uniformity and an excellent adsorption property.

When the electrostatic chuck 40 further includes a resistance heating element, it can function as an electrostatic chuck which can be subjected to heating treatment. In FIGS. 4A, 4B, when the electrostatic electrode 42 is an RF (radio frequency) electrode, the ceramic member can function as a susceptor. The RF electrode receives power supply to excite reaction gas. Specifically, the RF electrode can excite halogen corrosive gas or film formation gas used in etching or plasma CVD. In this case, when the susceptor further includes a resistance heating element, it can function as a susceptor which can be subjected to heating treatment.

While the present invention is explained below in more detail by Examples below, the invention is not limited thereto.

### Examples 1 to 5 and Comparative Example 1

First, the average particle size of aluminum nitride powder having a purity of 99.9% by weight was adjusted to those shown in Table 1. As a sintering aid, 5% by weight of yttria powder having an average particle size of 1.3 μm and a purity of 99.9% by weight was added to 95% by weight of the aluminum nitride powder was added, and they were mixed with each other using a ball mill. A binder (PVA) and isopropyl alcohol (IPA) were added to the resultant mixed powder, and they were mixed together to prepare a slurry. The slurry was subjected to granulation by a spray granulation method to prepare granulated powder.

A mold was filled with the granulated powder and subjected to molding to form an aluminum nitride molded material as a ceramic compact. As a metallic member, coiled molybdenum was put on the aluminum nitride molded material. The portion above the aluminum nitride molded material and molybdenum in the mold was filled with the granulated powder and subjected to molding to form an aluminum nitride molded material having molybdenum embedded therein. Specifically, an aluminum nitride molded material in a disc form having a diameter of 50 mm and a thickness of 10 mm was formed.

In Examples 1 to 5, the aluminum nitride molded material having molybdenum embedded therein was placed in a sintering furnace and retained in an atmosphere under a reduced pressure of 1×10⁻³ Torr at 1600° C. for one hour. Nitrogen gas was then introduced into the sintering furnace and the temperature in the furnace was raised to 1750° C. and maintained at 1750° C. for 4 hours. A hot press method was used as a sintering method, and pressing was conducted at 100 kgf/cm². In this way, a ceramic member having molybdenum embedded in the aluminum nitride sintered material was prepared. In Comparative Example 1, sintering was performed in substantially the same manner as in Examples 1 to 5 except that the retention in an atmosphere under a reduced pressure was not conducted, that is, sintering was performed by a hot press method in nitrogen gas at 1750° C.

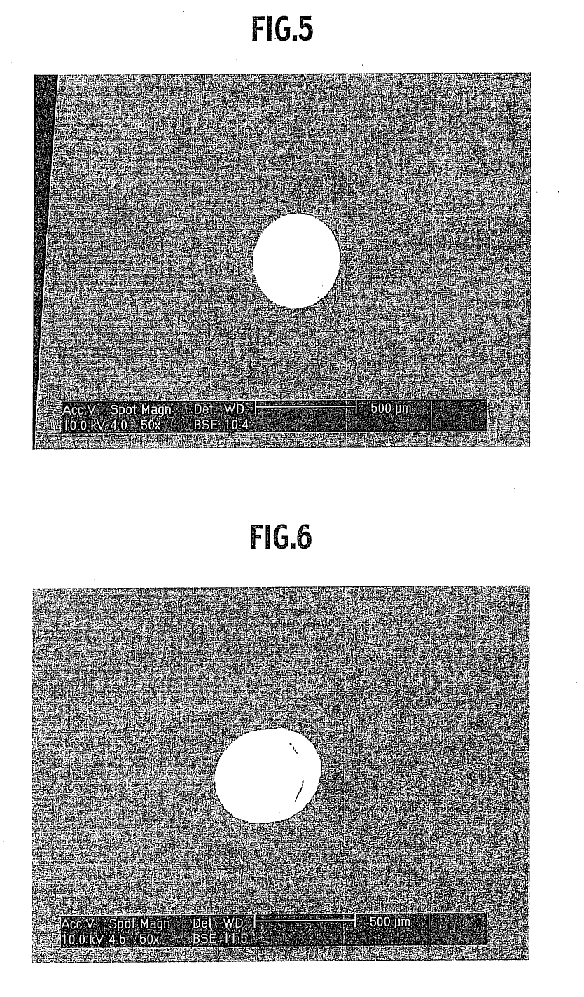

The density D(pr) of the aluminum nitride molded material and the density D(1600) of the aluminum nitride sintered material at 1600° C. were measured, and the relative density Dr(pr) of the ceramic compact and the relative density Dr(1600) of the ceramic sintered body at 1600° C. in the sintering step were determined using the formulae (2) and (3) above. The theoretical density of the aluminum nitride sintered material was determined by making calculation based on the linear law of mixture using the theoretical density of aluminum nitride, the alumina amount determined from the impurity oxygen amount contained in the aluminum nitride powder as a raw material, and the theoretical density of a compound formed from the yttria powder as a sintering aid. In addition, a portion around the molybdenum was examined under a scanning electron microscope (SEM) to measure a thickness of the affected layer around the molybdenum. Furthermore, volume resistance R1 of the molybdenum prior to the sintering and volume resistance R2 of the molybdenum after the sintering were measured, and the volume resistance change rate Rr of the molybdenum was determined using the formula (1) above. The results of the evaluation are shown in Table 1. The results of the examinations of portions around the molybdenum in the ceramic members in the Example 5 and the Comparative Example 1 are, respectively, shown in FIGS. 5 and 6.

TABLE 1

| | | | RELATIVE DENSITY | THICKNESS | |
|---|---|---|---|---|---|
| | AVERAGE | RELATIVE DENSITY | Dr(1600)(%) | OF | CHANGE |
| | PARTICLE | Dr(pr)(%) | OF 1600° C. CERAMIC | AFFECTED LAYER | RATE(%) |
| | SIZE(μm) | OF CERAMIC COMPACT | SINTERED BODY | (μm) | [(R2 − R1)/R1] |
| EXAMPLE 1 | 1.4 | 43 | 81 | 230 | 16 |
| | | | | | [0.16] |
| EXAMPLE 2 | 1.3 | 46 | 88 | 210 | 13 |
| | | | | | [0.13] |
| EXAMPLE 3 | 1.1 | 46 | 92 | 110 | 6 |
| | | | | | [0.06] |
| EXAMPLE 4 | 1.0 | 43 | 96 | 60 | 1 |
| | | | | | [−0.01] |
| EXAMPLE 5 | 0.74 | 40 | 100 | 0 | 4 |
| | | | | | [−0.04] |
| COMPARATIVE | 1.6 | 38 | 74 | 650 | 25 |
| EXAMPLE 1 | | | | | [0.25] |

As can be seen from Table 1, in each of the aluminum nitride sintered materials in the Examples 1 to 5 in which the aluminum nitride powder had an average particle size adjusted to 0.5 to 1.5 μm and the ceramic compact had a relative density adjusted to 40% or more, the ceramic sintered body at 1600° C. in the sintering step had a relative density of 80% or more. In each of the ceramic members in the Examples 1 to 5 in which the aluminum nitride sintered material at 1600° C. in the sintering step had a relative density adjusted to 80% or more and an atmosphere under a reduced pressure at 1600° C. was retained, the affected layer had a thickness as small as 300 μm or less, and both the aluminum nitride sintered material and the molybdenum were satisfactorily prevented from changing in properties. In addition, each molybdenum in the Examples 1 to 5 had a volume resistance change rate as small as 20% or less.

Particularly, in each of the ceramic members in the Examples 4 and 5 in which the aluminum nitride powder has an average particle size adjusted to 0.5 to 1.0 μm, the ceramic sintered body at 1600° C. in the sintering step had a relative density as large as 95% or more. As a result, the affected layer had a thickness as small as 100 μm or less and the molybdenum had a volume resistance change rate as small as 5% or less, and the aluminum nitride sintered material and the molybdenum were securely prevented from changing in properties. Especially in the Example 5, as can be seen in FIG. 5, no affected layer was formed, and almost no change in properties was found in the aluminum nitride sintered material and the molybdenum.

In contrast, in the Comparative Example 1, the aluminum nitride molded material had a relative density of less than 40%, and the ceramic sintered body at 1600° C. in the sintering step had a relative density of less than 80%. Furthermore, in the ceramic member in the Comparative Example 1 in which an atmosphere under a reduced pressure was not retained, the affected layer has a thickness as large as more than 650 μm, and both the aluminum nitride sintered material and the molybdenum markedly changed in properties. As can be seen in FIG. 6, there are an area where a large number of grain boundary phases are present and another area where only a very small number of grain boundary phases are present, and the affected layer was formed in a wide region. Furthermore, in the Comparative Example 1, the molybdenum was considerably carbonized due to the sintering, and hence had a volume resistance change rate as large as 25%.

While the embodiment of the present invention has been described above, the invention is not limited to the above embodiment and changes and modifications can be made within the scope of the gist of the present invention.

What is claimed is:

1. A method for producing a ceramic member, comprising the steps of:
forming a ceramic compact having a relative density adjusted to 40% or more;
forming a metallic member comprising a metal element such that the metallic member is in contact with the ceramic compact; and
sintering the ceramic compact and the metallic member in an atmosphere under a reduced pressure at a temperature in the range of from 1500 to 1700° C. so that a ceramic sintered body has a relative density adjusted to 80% or more at 1600° C.

2. The method according to claim 1, wherein the metallic member has a volume resistance change rate of 20% or less in the sintering step.

3. The method according to claim 1, wherein the relative density of the ceramic compact is adjusted by changing at least one of an average particle size of a ceramic raw material powder, a type of an added sintering aid, an amount of an added sintering aid, and a forming pressure of the ceramic compact, and wherein the relative density of the ceramic sintered body is adjusted by changing at least one of the average particle size of the ceramic raw material powder, the type of the added sintering aid, the amount of the added sintering aid, the forming pressure of the ceramic compact, and sintering conditions.

4. The method according to claim 1, wherein the sintering step is performed using a hot press method.
